(19) United States
(12) Patent Application Publication
(10) Pub. No.: US 2025/0237918 A1
(43) Pub. Date: Jul. 24, 2025

(54) OPTICAL ELEMENT AND OPTICAL SENSOR

(71) Applicant: FUJIFILM Corporation, Tokyo (JP)

(72) Inventors: Yukito Saitoh, Minamiashigara-shi (JP); Kazuya Hisanaga, Minamiashigara-shi (JP)

(73) Assignee: FUJIFILM Corporation, Tokyo (JP)

(21) Appl. No.: 19/063,702

(22) Filed: Feb. 26, 2025

Related U.S. Application Data
(63) Continuation of application No. PCT/JP2023/031263, filed on Aug. 29, 2023.

(30) Foreign Application Priority Data
Sep. 12, 2022 (JP) 2022-144686

(51) Int. Cl. G02F 1/137; G01N 21/41

(52) U.S. Cl. CPC G02F 1/13718; G01N 21/41

(57) ABSTRACT

Provided are an optical element capable of more easily detecting a change in refractive index of an object to be measured without sweeping a wavelength of incidence light, and an optical sensor using the optical element. An optical element includes a liquid crystal layer that is formed of a composition including a liquid crystal compound, in which the liquid crystal layer has a liquid crystal alignment pattern in which an orientation of an optical axis derived from the liquid crystal compound changes while continuously rotating toward at least one direction of in-plane directions, in a case where a length over which the orientation of the optical axis derived from the liquid crystal compound rotates by 180° in a plane is set as a single period, a length of the single period in the liquid crystal alignment pattern gradually changes in the one direction, and the liquid crystal layer has a resonance structure.

### CROSS-REFERENCE TO RELATED APPLICATIONS

This application is a Continuation of PCT International Application No. PCT/JP2023/031263 filed on Aug. 29, 2023, which claims priority under 35 U.S.C. § 119 (a) to Japanese Patent Application No. 2022-144686 filed on Sep. 12, 2022. The above applications are hereby expressly incorporated by reference, in their entirety, into the present application.

### BACKGROUND OF THE INVENTION

### 1. Field of the Invention

The present invention relates to an optical element used for an optical sensor or the like and an optical sensor using the optical element.

### 2. Description of the Related Art

As an optical element using an optical phenomenon by a fine structure of a thing, an optical element (optical device) using a guided-mode resonance phenomenon is known.

The optical element using the guided-mode resonance phenomenon is a diffraction element (diffraction grating) including a subwavelength grating where a period in a periodic structure is shorter than a wavelength of target light.

In a case where light is incident into the subwavelength grating, emission of diffracted light to an incidence side is suppressed. On the other hand, due to a difference in refractive index from that in the surroundings, light in a specific wavelength range is guided while being repeatedly reflected, and thus resonance occurs. As a result of the occurrence of the resonance, the light having the specific wavelength is strongly emitted as reflected light.

As described in JP2020-139972A, the optical element using the guided-mode resonance phenomenon is used, for example, for a wavelength selective filter.

As a method of manufacturing the optical element, a manufacturing method using a semiconductor manufacturing technique is known. However, this manufacturing method has a problem in that it is complicated.

On the other hand, as the optical element using the guided-mode resonance phenomenon that can be easily prepared, for example, Zhiyong Yang et al., Polarization independent guided-mode resonance in liquid crystal-based polarization gratings, Vol. 3, No. 11/15 Nov. 2020, OSA Continuum, pp. 3107-3115 describes an optical element using a liquid crystal diffraction element.

The optical element that causes the guided-mode resonance phenomenon to occur disclosed in Zhiyong Yang et al., Polarization independent guided-mode resonance in liquid crystal-based polarization gratings, Vol. 3, No. 11/15 Nov. 2020, OSA Continuum, pp. 3107-3115 includes a liquid crystal layer having a liquid crystal alignment pattern in which an optical axis derived from a liquid crystal compound continuously rotates toward one in-plane direction. This liquid crystal layer acts as a liquid crystal diffraction element having a subwavelength grating.

### SUMMARY OF THE INVENTION

The selective reflection wavelength range of the liquid crystal diffraction element (optical element) that causes the guided-mode resonance phenomenon is sensitive to a change in refractive index around the liquid crystal diffraction element, that is, the liquid crystal layer. Therefore, such an optical element can be suitably used as a refractive index sensor. Specifically, the peak wavelength of reflected light is shifted depending on the refractive index of the member disposed on the liquid crystal layer in the optical element. Accordingly, the refractive index of the object to be measured can be obtained by disposing the object to be measured on the liquid crystal layer included in the optical element and measuring the position of the peak wavelength of the reflected light.

However, in order to detect the shift of the peak wavelength of the reflected light, a device capable of finely sweeping the wavelength of incidence light, such as a high-precision spectroscope, is required, and a device capable of more easily detecting the refractive index of the object to be measured has been required.

An object of the present invention is to solve the above-described problem of the related art and to provide an optical element capable of more easily detecting a refractive index of an object to be measured without sweeping a wavelength of incidence light, and an optical sensor using the optical element.

In order to achieve the object, the present invention has the following configurations.

[1] An optical element comprising:
a liquid crystal layer that is formed of a composition including a liquid crystal compound,
in which the liquid crystal layer has a liquid crystal alignment pattern in which an orientation of an optical axis derived from the liquid crystal compound changes while continuously rotating toward at least one direction of in-plane directions,
in a case where a length over which the orientation of the optical axis derived from the liquid crystal compound rotates by 180° in a plane is set as a single period, a length of the single period in the liquid crystal alignment pattern gradually changes in the one direction, and
the liquid crystal layer further has a resonance structure.

[2] The optical element according to [1],
in which the length of the single period in the liquid crystal alignment pattern of the liquid crystal layer is 0.3 μm to 1.2 μm, and
a thickness of the liquid crystal layer is 1 μm to 5 μm.

[3] The optical element according to [1] or [2],
in which in a region where the length of the single period increases monotonically or decreases monotonically in the one direction, in a case where a length of the single period at a reference position is represented by Λ₁ and a length of the single period at a position spaced from the reference position by a distance x is represented by Λ_{X} with a certain point as a reference,
0<|Λ_{X}−Λ₁|/x≤1×10⁻² is satisfied.

[4] The optical element according to any one of [1] to [3],

in which the liquid crystal layer has a liquid crystal alignment pattern in which a rotation direction in which the orientation of the optical axis derived from the liquid crystal compound continuously rotates is reversed with a certain point as a boundary in a direction along the one direction.

[5] The optical element according to any one of [1] to [4],

in which the liquid crystal layer is a layer obtained by immobilizing a cholesteric liquid crystalline phase, and a helical pitch of the liquid crystal layer is 0.1 μm to 0.9 μm.

[6] An optical sensor comprising:

the optical element according to any one of [1] to [5].

According to the present invention, it is possible to provide an optical element that can more easily detect a change in refractive index of an object to be measured without sweeping a wavelength of incidence light, and an optical sensor using the optical element.

### BRIEF DESCRIPTION OF THE DRAWINGS

FIG. 1 is a diagram conceptually showing an example of an optical element according to the present invention.

FIG. 2 is an enlarged conceptual diagram showing a part of the liquid crystal layer of the optical element shown in FIG. 1.

FIG. 3 is a conceptual diagram showing a liquid crystal alignment pattern in a liquid crystal layer of the optical element according to the present invention.

FIG. 4 is a conceptual diagram showing an action of the optical element.

FIG. 5 is a graph conceptually showing a relationship between an in-plane position of the optical element and an intensity of transmitted light.

FIG. 6 is a diagram conceptually showing an example of the optical sensor according to the present invention including the optical element according to the present invention.

FIG. 7 is a diagram conceptually showing an intensity distribution of transmitted light detected by the optical sensor of FIG. 6.

FIG. 8 is a diagram conceptually showing an example of an optical element according to the present invention.

FIG. 9 is a diagram conceptually showing an intensity distribution of transmitted light detected by an optical sensor including the optical element shown in FIG. 8.

FIG. 10 is a diagram conceptually showing another example of the liquid crystal alignment pattern in the liquid crystal layer of the optical element according to the present invention.

FIG. 11 is a diagram conceptually showing an intensity distribution of transmitted light detected by an optical sensor including the optical element having the liquid crystal layer shown in FIG. 10.

FIG. 12 is a diagram conceptually showing another example of an optical element according to the present invention.

FIG. 13 is a conceptual diagram showing an example of an exposure device that exposes an alignment film.

FIG. 14 is a conceptual diagram showing another example of an exposure device that exposes an alignment film.

FIG. 15 is a conceptual diagram showing another example of an exposure device that exposes an alignment film.

### DESCRIPTION OF THE PREFERRED EMBODIMENTS

Hereinafter, an optical element and an optical sensor according to an embodiment of the present invention will be described in detail based on suitable examples shown in the accompanying drawings.

In the present specification, numerical ranges represented by “to” include numerical values before and after “to” as lower limit values and upper limit values.

In the present specification, “(meth)acrylate” represents “either or both of acrylate and methacrylate”.

In the present specification, the meaning of the term “the same” or the like includes a case where an error range is generally allowable in the technical field.

### [Optical Element]

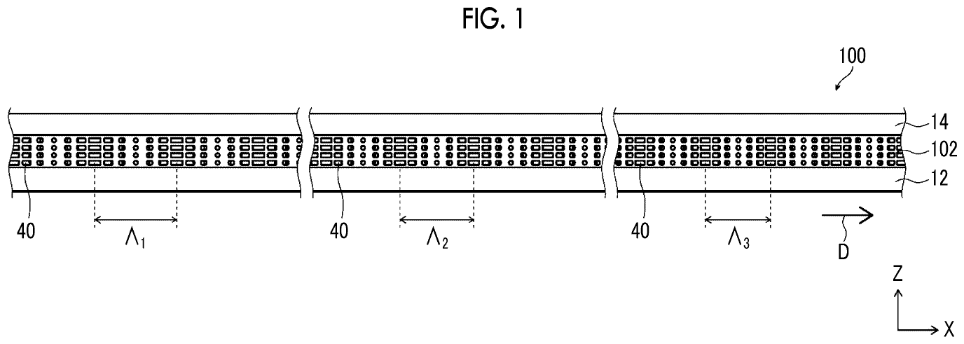

FIG. 1 is a diagram conceptually showing an example of the optical element according to the embodiment of the present invention.

An optical element 100 shown in FIG. 1 includes a first sheet 12, a second sheet 14, and a liquid crystal layer 102 sandwiched between the first sheet and the second sheet 14.

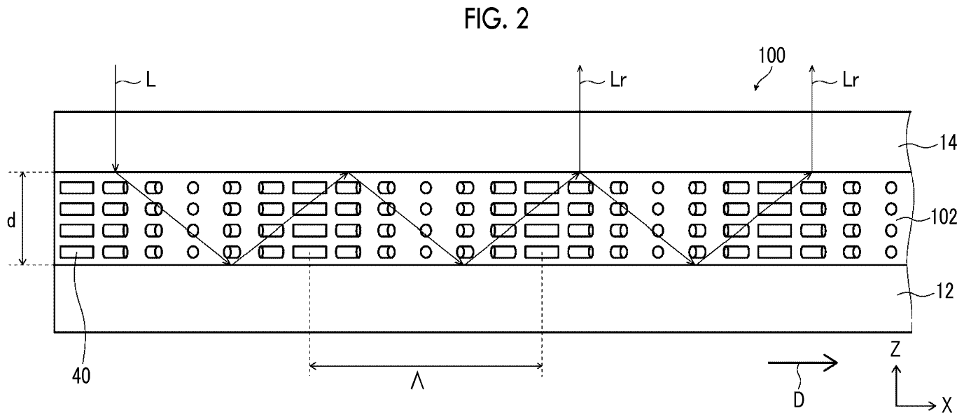

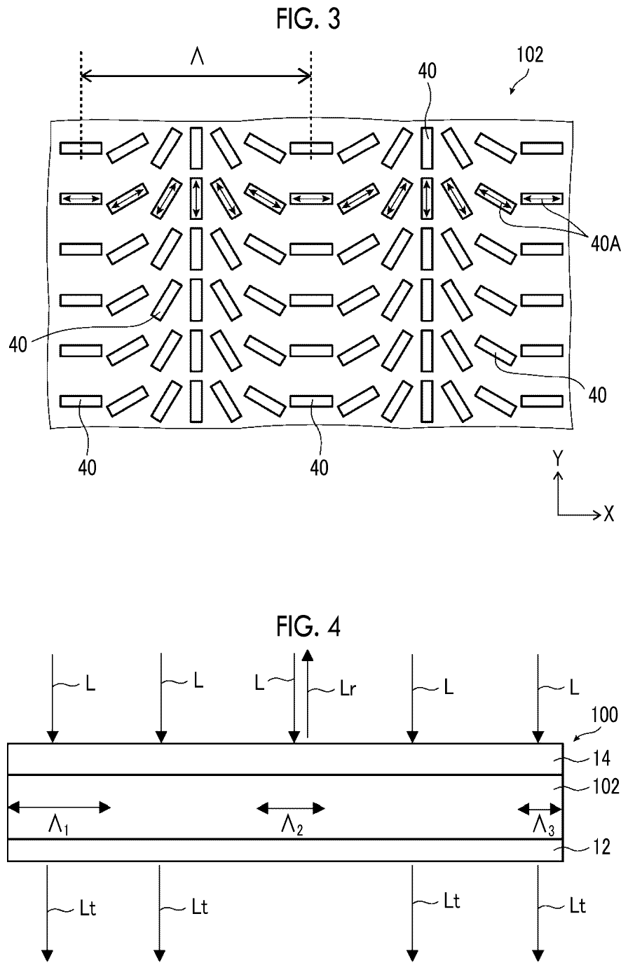

FIG. 2 is an enlarged conceptual diagram showing a part of the optical element 100 shown in FIG. 1. FIG. 3 is a top view of the liquid crystal layer 102 in the optical element 100 shown in FIG. 2.

In the optical element 100 according to the embodiment of the present invention, as conceptually shown in FIGS. 2 and 3, the liquid crystal layer 102 has a liquid crystal alignment pattern in which an orientation of an optical axis 40A derived from a liquid crystal compound 40 changes while continuously rotating toward one direction (X direction). FIG. 3 is a diagram conceptually showing the liquid crystal alignment pattern in a plane (plane direction of a main surface) of the liquid crystal layer 102.

In addition, the liquid crystal layer 102 has a resonance structure that causes a guided-mode resonance phenomenon to occur.

Further, in the liquid crystal layer 102, in a case where a length over which the orientation of the optical axis 40A derived from the liquid crystal compound 40 rotates by 180° in a plane is set as a single period A, the length of the single period A in the liquid crystal alignment pattern gradually changes in the one direction.

This liquid crystal layer 102 will be described below.

### [First Sheet and Second Sheet]

The optical element 100 in the example shown in the drawing has a configuration in which the liquid crystal layer 102 is sandwiched between the first sheet 12 and the second sheet 14.

The first sheet 12 and the second sheet 14 are sheet-shaped materials having a lower refractive index than the liquid crystal layer 102. The optical element 100 has such a configuration, and thus, as shown in FIG. 2, the incident light L is totally reflected and repeatedly propagates in the liquid crystal layer 102. Here, the refractive index of the liquid crystal layer 102 is an average refractive index of the liquid crystal compound.

The first sheet 12 and the second sheet 14 are not particularly limited, and various well-known sheet-shaped materials (films, layers, or plate-shaped materials) can be used as long as they have a lower refractive index than the liquid crystal layer 102.

Accordingly, each of the first sheet 12 and the second sheet 14 may have a monolayer structure or a multilayer structure.

Examples of the first sheet 12 and the second sheet 14 having a monolayer structure include sheets formed of glass or various resin materials such as triacetyl cellulose (TAC), polyethylene terephthalate (PET), polycarbonates, polyvinyl chloride, acryl, or polyolefin.

Examples of the first sheet 12 and the second sheet 14 having a multilayer structure include a sheet including: one of the above-described sheets having a monolayer structure that is provided as a substrate; and another layer that is provided on a surface of the substrate.

Examples of the first sheet 12 and the second sheet 14 include a sheet formed of a substrate and a bonding layer, in which the substrate is bonded to the liquid crystal layer 102 using the bonding layer.

The bonding layer may be a layer formed of an adhesive, may be a layer formed of a pressure sensitive adhesive, or a layer formed of a material having properties of both of an adhesive or a pressure sensitive adhesive as long as it has a sufficient light-transmitting property. The adhesive has fluidity during bonding and is subsequently solidified. The pressure sensitive adhesive is a gelled (rubber-like) flexible solid during bonding, and the gelled state does not change subsequently.

Accordingly, the bonding layer may be any well-known layer that is used for bonding sheet-shaped materials in various optical devices, for example, an optical clear adhesive (OCA), an optically transparent double-sided tape, or an ultraviolet curable resin.

A transmittance of the first sheet 12 and the second sheet 14 with respect to corresponding light is preferably 50% or more, more preferably 70% or more, and still more preferably 85% or more.

The thickness of the first sheet 12 and the second sheet 14 is not particularly limited and may be appropriately set depending on the use of the optical element 100, a material for forming the first sheet 12 and the second sheet 14, a layer configuration of the first sheet 12 and the second sheet 14, and the like.

In addition, the first sheet 12 and the second sheet 14 may be the same as or different from each other.

In the optical element according to the embodiment of the present invention, the liquid crystal layer 102 and the medium in contact with the main surface of the liquid crystal layer 102 are not particularly limited as long as the liquid crystal layer 102 has a higher refractive index. Accordingly, in the optical element according to the embodiment of the present invention, the medium in contact with the main surface of the liquid crystal layer 102 may be gas such as air layer (atmosphere).

That is, the optical element according to the embodiment of the present invention may include the liquid crystal layer 102 and only one of the first sheet 12 and the second sheet 14, or may be configured of only the liquid crystal layer 102.

The main surface is the maximum surface of a sheet-shaped material (a film, a plate-shaped material, or a layer) and normally corresponds to both surfaces in a thickness direction of the sheet-shaped material.

### [Liquid Crystal Layer]

In the optical element 100, the liquid crystal layer 102 is provided between the first sheet 12 and the second sheet 14.

As conceptually shown in FIGS. 2 and 3, the liquid crystal layer 102 has the liquid crystal alignment pattern in which the orientation of the optical axis 40A derived from the liquid crystal compound 40 changes while continuously rotating toward the one in-plane direction. In addition, in the following description, “the optical axis derived from the liquid crystal compound” will also be referred to as “the optical axis of the liquid crystal compound” or simply “the optical axis”. In addition, the axis along the one direction in which the optical axis of the liquid crystal compound changes rotationally is also referred to as an arrangement axis.

Specifically, as shown in FIG. 3, in the plane direction of the main surface of the liquid crystal layer 102, the liquid crystal compounds 40 are arranged in the X direction and a Y direction orthogonal to each other. In FIG. 2, the Y direction is a direction orthogonal to the paper plane.

In addition, the orientation of the optical axis 40A of the liquid crystal compound 40 changes while continuously rotating in the X direction that is the one in-plane direction of the liquid crystal layer 102. In addition, in the Y direction, the liquid crystal compounds 40 in which the directions of the optical axes 40A are the same are aligned at regular intervals.

As shown in FIG. 1, in the liquid crystal layer 102, the liquid crystal compound 40 is twisted and aligned, and laminated in the thickness direction (Z direction). In FIG. 3, the thickness direction, that is, the Z direction is a direction orthogonal to the paper plane.

“The orientation of the optical axis 40A of the liquid crystal compound 40 changes while continuously rotating in the one in-plane direction” represents that angles between the optical axes 40A and the X direction vary depending on positions in the X direction and the angle between the optical axis 40A and the X direction gradually changes from θ to θ+180° or θ-180° in the X direction. That is, in each of the plurality of liquid crystal compounds 40 arranged in the X direction, as shown in FIG. 3, the optical axis 40A changes in the X direction while rotating on a given angle basis.

A difference between the angles of the optical axes 40A adjacent to each other in the X direction is not particularly limited and is preferably 45° or less, more preferably 15° or less, and still more preferably less than 15°.

In addition, in the present invention, in a case where the liquid crystal compound 40 is a rod-like liquid crystal compound, the optical axis 40A of the liquid crystal compound 40 refers to a molecular major axis of the rod-like liquid crystal compound. On the other hand, in a case where the liquid crystal compound 40 is a disk-like liquid crystal compound, the optical axis 40A of the liquid crystal compound 40 refers to an axis parallel to the normal direction with respect to a disc plane of the disk-like liquid crystal compound.

In the example shown in the drawing, a rod-like liquid crystal compound is shown as the liquid crystal compound 40.

In the liquid crystal layer 102, in the liquid crystal alignment pattern of the liquid crystal compound 40, the length (distance) over which the optical axis 40A of the liquid crystal compound 40 rotates by 180° in the X direction in which the optical axis 40A changes while continuously rotating in a plane is a single period in the liquid crystal alignment pattern.

That is, a distance between centers of two liquid crystal compounds 40 in the X direction is the single period in the liquid crystal alignment pattern, the two liquid crystal compounds having the same angle in the X direction. Specifically, as shown in FIG. 3, a distance between centers in the X direction of two liquid crystal compounds 40 in which the X direction and the orientation of the optical axis 40A match each other is the single period in the liquid crystal alignment pattern.

In the liquid crystal alignment pattern of the liquid crystal layer 102, the single period is repeated in the X direction, that is, in the one direction in which the orientation of the optical axis 40A changes while continuously rotating.

As described above, the liquid crystal layer 102 acts as a liquid crystal diffraction element. In the liquid crystal layer 102, the single period in the liquid crystal alignment pattern is a period A (single period A) in a periodic structure of the diffraction element (diffraction grating).

Here, the liquid crystal layer 102 has a resonance structure that causes the above-described guided-mode resonance phenomenon to occur. Accordingly, the liquid crystal layer 102 acts as a diffraction grating having a subwavelength grating where the period A is shorter than a wavelength of light to be selectively reflected from the optical element 100 (liquid crystal layer 102).

This point will be described below.

On the other hand, in the liquid crystal compound 40 forming the liquid crystal layer 102, the directions of the optical axes 40A are the same in the Y direction orthogonal to the X direction, that is, the Y direction orthogonal to the one direction in which the optical axis 40A continuously rotates.

In other words, in the liquid crystal compound 40 forming the liquid crystal layer 102, angles between the optical axes 40A of the liquid crystal compound 40 and the X direction are the same in the Y direction.

The liquid crystal layer 102 having the liquid crystal alignment pattern can be formed of, for example, an alignment film for aligning a liquid crystal compound 40 to the predetermined liquid crystal alignment pattern, the alignment film having an alignment pattern corresponding to the liquid crystal alignment pattern.

In the optical element according to the embodiment of the present invention, the alignment film may be used as any one of the first sheet 12 or the second sheet 14.

Here, as described above, in the present invention, as shown in FIG. 1, in the liquid crystal layer 102, the length of the single period A in the liquid crystal alignment pattern gradually changes in the one direction. In the example shown in FIG. 1, the orientation of the optical axis 40A derived from the liquid crystal compound 40 rotates in the left-right direction (the direction of the arrow D) in the drawing, and in a case where the single period of the liquid crystal alignment pattern in the region on the left side in the drawing is represented by Λ₁, the single period of the liquid crystal alignment pattern in the region in the center in the drawing is represented by Λ₂, and the single period of the liquid crystal alignment pattern in the region on the right side in the drawing is represented by Λ₃, Λ₁>Λ₂>Λ₃ is satisfied. That is, in the example shown in FIG. 1, the single period A of the liquid crystal alignment pattern changes to gradually decrease from the left side to the right side in the drawing.

### <Effect of Optical Element>

The optical element according to the embodiment of the present invention has such a configuration, and thus, in a case where light having a single wavelength is incident, the light is reflected only at a specific position in a plane, and the in-plane position where the light is reflected varies depending on the wavelength of the incident light. In addition, in a case where the refractive index around the optical element (liquid crystal layer) changes, a position where light having a certain wavelength is reflected changes. Therefore, the optical element can be used as a high-accuracy refractive index sensor.

The action of the optical element according to the embodiment of the present invention will be described below.

First, the guided-mode resonance phenomenon of the liquid crystal layer will be described.

As shown in FIG. 2, in a case where the light Lis incident into the optical element 100, the light Lis incident into the liquid crystal layer 102 and is diffracted.

The light L incident into the liquid crystal layer 102 is diffracted such that emission of diffracted light to the incidence side, that is, the second sheet 14 side in the example shown in the drawing is suppressed. In addition, the light L incident into the liquid crystal layer 102 is guided in the liquid crystal layer 102 while being repeatedly totally reflected due to a difference in refractive index between the liquid crystal layer 102 and each of the first sheet 12 and the second sheet 14 and the like.

Here, by guiding the light in the specific wavelength range in the light to be guided, the guided-mode resonance phenomenon where the guiding of the light and the period A of the liquid crystal layer 102 as the subwavelength grating resonate with each other occurs.

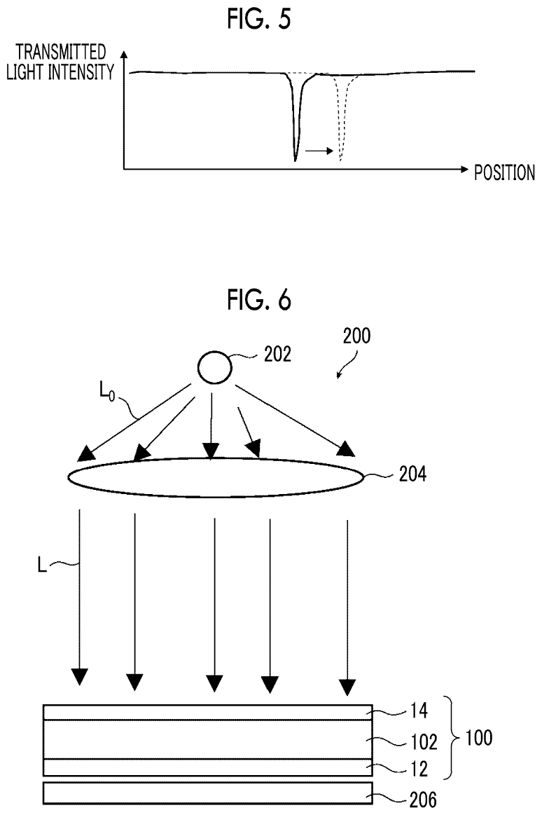

As a result, as shown in FIG. 5, the light in the specific wavelength range is emitted from the liquid crystal layer 102 while being guided, and is emitted as strong reflected light Lr from the optical element 100.

Specifically, an angle of diffraction in the diffraction element varies depending on the wavelength of the light.

Therefore, the light in the specific wavelength range is diffracted by the liquid crystal layer 102, and thus, the guided wave of the light and the single period A resonate with each other in a relationship between the thickness d of the liquid crystal layer 102 and the single period A of the liquid crystal alignment pattern of the liquid crystal layer 102, which is the subwavelength grating, according to the diffraction angle. Due to this resonance, the light in the specific wavelength range is amplified while being guided, and is emitted as the strong reflected light Lr from the liquid crystal layer 102, that is, the optical element 100.

For example, in a case where white light is incident as the light L, light in a wavelength range of a part of red light, light in a wavelength range of a part of green light, or light in a wavelength range of a part of blue light is emitted as the strong reflected light Lr from the optical element 100.

That is, the liquid crystal layer 102 has a resonance structure corresponding to the wavelength of the light and the relationship between the thickness d of the liquid crystal layer and the single period A of the liquid crystal layer 102 as the subwavelength grating.

In other words, the liquid crystal layer 102 has the structure that causes resonance (guided-mode resonance phenomenon) to occur between the light to be guided and the single period A of the subwavelength grating according to the wavelength of the light and the relationship between the thickness d of the liquid crystal layer and the single period A of the liquid crystal layer 102.

Light other than the light in the specific wavelength range emitted as the reflected light Lr exits to the side opposite to the reflected light Lr such that the light is not guided in the liquid crystal layer 102 or transmits through the optical element 100 (liquid crystal layer 102) while being guided in the liquid crystal layer 102.

Here, in the optical element according to the embodiment of the present invention, as shown in FIG. 1, in the liquid crystal layer 102, the length of the single period A in the liquid crystal alignment pattern gradually changes in the one direction.

As described above, the guided-mode resonance phenomenon occurs depending on a relationship between the wavelength of light, the thickness d of the liquid crystal layer, and the single period A of the liquid crystal layer 102. Therefore, in a case where the single period A of the liquid crystal layer 102 changes, the wavelength at which the guided-mode resonance phenomenon occurs changes. Accordingly, as shown in FIG. 4, in a case where the length of the single period A in the liquid crystal alignment pattern of the liquid crystal layer 102 gradually changes in the one direction, light is reflected by a resonance phenomenon only at a specific position having the single period A that causes resonance with light having a wavelength in a case where light having a certain single wavelength is incident, and the light is transmitted in other regions (transmitted light Lt). Accordingly, as conceptually shown in FIG. 5, the intensity of transmitted light in a case where light having a single wavelength is incident on the optical element shows a minimum value at a certain position in a plane and shows a high intensity of transmitted light at other positions.

In addition, as described above, the light L incident into the liquid crystal layer 102 is repeatedly totally reflected and guided in the liquid crystal layer 102 due to a difference in refractive index between the liquid crystal layer 102 and the first sheet 12 and the second sheet 14, and the like. Therefore, in a case where the refractive index of the periphery of the liquid crystal layer 102 changes, that is, in a case where the refractive index of the first sheet 12 and/or the second sheet 14 changes, the relationship between the wavelength of light and the single period A of the liquid crystal layer 102, in which resonance occurs due to the guided-mode resonance phenomenon, changes. That is, in a case where the refractive index of the periphery of the liquid crystal layer 102 changes, the single period A that causes resonance with light having a certain single wavelength changes in a case where the light having the single wavelength is incident. Therefore, the position having the single period A at which resonance occurs with light having this wavelength changes, and the position at which light is reflected changes. Accordingly, as shown by a broken line in FIG. 5, the position of the minimum value of the transmitted light intensity changes.

As described above, in the optical element according to the embodiment of the present invention, the refractive index in the periphery of the liquid crystal layer can be detected as the position of the minimum value of the intensity of transmitted light. Therefore, the refractive index of the object to be measured can be obtained by grasping the relationship between the refractive index of the substance disposed on the liquid crystal layer (optical element) in advance and the position of the peak wavelength of the reflected light, disposing the object to be measured, of which the refractive index is unknown, on the liquid crystal layer (optical element), and measuring the position of the peak wavelength of the reflected light. In this case, since it is not necessary to sweep the wavelength of incidence light, a device capable of finely sweeping the wavelength of incidence light, such as a high-accuracy spectroscope, is not necessary, and the refractive index of the object to be measured can be more easily detected.

The single period A in the liquid crystal layer 102, that is, the subwavelength grating is not limited, but is set to be smaller than the wavelength of light to be selectively reflected. More specifically, the single period A of the liquid crystal layer 102 is small to the extent that a diffracted wave is not generated in a layer outside the liquid crystal layer 102, and is large to the extent that a first-order diffracted wave is generated in the liquid crystal layer 102 having a higher refractive index than the outside layer. In addition, the single period A where the resonance structure that causes the guided-mode resonance phenomenon to occur can be formed may be appropriately set depending on the wavelength range of light to be selectively reflected, the thickness of the liquid crystal layer 102, and the like. The single period A of the liquid crystal layer 102 is preferably 0.3 to 1.2 μm and more preferably 0.4 to 1 μm.

In addition, the thickness d of the liquid crystal layer 102 is not particularly limited, and the thickness d where the resonance structure that causes the guided-mode resonance phenomenon to occur can be formed may be appropriately set depending on the wavelength range of light to be selectively reflected, the single period A of the liquid crystal layer 102, and the like. The thickness of the liquid crystal layer 102 is preferably 1 to 5 μm and more preferably 1.5 to 4 μm. The thickness d is determined depending on the value of the wavelength to be reflected, and as the wavelength increases, the thickness d increases. In a case where an incidence angle of light source light increases, an optical path length increases. Therefore, in general, the thickness d is set to be small accordingly.

In addition, the liquid crystal layer is configured such that the single period A in the liquid crystal alignment pattern gradually changes in the one in-plane direction, but in a case where the degree of change in the single period A is too large, the guided-mode resonance phenomenon may not easily occur. On the other hand, in a case where the degree of change of the single period A is too small, the measurable range of the refractive index is narrowed. From the viewpoint that the guided-mode resonance phenomenon can be reliably caused and the refractive index in a sufficient range can be measured, in a region where the length of the single period A in the one direction in which the orientation of the optical axis derived from the liquid crystal compound rotates and changes monotonically increases or monotonically decreases, in a case where a length of the single period at a reference position is represented by Λ₁ and a length of the single period at a position spaced apart from the reference position by a distance x is represented by Λ_{X}, it is preferable that 0<|Λ_{X}−Λ₁|/x≤1×10⁻² is satisfied, more preferable that 0<|Λ_{X}−Λ₁|/x≤5×10⁻³ is satisfied, and still more preferable that 0<|Λ_{X}−Λ₁|/x≤1×10⁻³ is satisfied.

Here, the region where the length of the single period A in the one direction in which the orientation of the optical axis derived from the liquid crystal compound changes while rotating monotonically increases or monotonically decreases can be specified by observing the morphology with a microscope. In addition, the length Λ₁ of the single period at the reference position and the length Λ_{X} of the single period at the position spaced by the distance x are obtained from the distance between the position rotated by −90° from the orientation of the optical axis at the point and the position rotated by 90° from the orientation of the optical axis at the point. A method of obtaining |Λ_{X}−Δ₁|/x is a method of dividing an absolute value of a difference between a length Λ₁ of the single period at the reference point and a length Λ_{X} of the single period at the position spaced from the reference point by the distance x by the distance x, and corresponds to the position derivative of the single period. In a case where the reference point is an end of one side of the element and a position spaced by a distance x is an end of the element on the opposite side, |Λ_{X}−Δ₁|/x represents a position derivative of the single period of the entire element.

In addition, the distance x from the reference position is not limited, but is preferably 1 mm to 20 mm, more preferably 1 mm to 10 mm, and still more preferably 1 mm to 5 mm.

In the present invention, the fact that the single period A in the liquid crystal alignment pattern of the liquid crystal layer gradually changes in the one direction means that the single period A may continuously change in the one direction or may change in a stepwise manner in the one direction as long as the single period A increases or decreases in the one direction.

In addition, in the present invention, the region where the length of the single period A monotonically increases refers to a region where the length of the single period A increases or remains constant in the one direction and does not decrease, and the region where the length of the single period A monotonically decreases refers to a region where the length of the single period A decreases or remains constant in the one direction and does not increase.

In addition, as described above, the first sheet 12 and the second sheet 14 between which the liquid crystal layer 102 is sandwiched have a lower refractive index than the liquid crystal layer.

The refractive index of the first sheet 12 and the second sheet 14 needs only be lower than the liquid crystal layer 102. A difference in refractive index between each of the first sheet 12 and the second sheet 14 and the liquid crystal layer 102 is not particularly limited and is preferably 0.05 to 1 and more preferably 0.05 to 0.7.

In addition, an alignment film that aligns liquid crystal may be provided between the liquid crystal layer 102 and the first sheet or the second sheet.

The film thickness, the refractive index, and the like of the alignment film are not particularly limited, but the film thickness is desirably small to the extent that the resonance phenomenon does not deteriorate. In addition, the refractive index of the alignment film is desirably close to that of any one of the liquid crystal layer, the first sheet, or the second sheet. Further, the film thickness and the refractive index of the alignment film can be appropriately set depending on the wavelength range of light to be selectively reflected, the thickness of the liquid crystal layer 102, and the like. The thickness of the alignment film is preferably 0.005 to 0.2 μm, more preferably 0.01 to 0.15 μm, and still more preferably 0.02 to 0.1 μm.

In addition, in an aspect where the alignment film is not used, the liquid crystal layer may be configured to be transferred to the first sheet or the second sheet. Further, the first sheet and the second sheet may be in any state of solid, liquid, or gas.

### [Optical Sensor]

The optical sensor according to the embodiment of the present invention, which has the optical element, will be described with reference to FIG. 6.

FIG. 6 is a diagram conceptually showing an example of the optical sensor according to the embodiment of the present invention.

As shown in FIG. 6, the optical sensor 200 includes a light source 202, a lens 204, the above-described optical element 100, and a light receiver 206.

The light source 202 is a well-known light source in the related art that emits light having a single wavelength. Specifically, as the light source 202, known light sources such as light emitting diodes (LEDs), organic light emitting diodes (OLEDs), an infrared laser, a vertical cavity surface emitting laser (VCSEL), a glover, a xenon lamp, and a halogen lamp are available.

In addition, the wavelength of the light emitted from the light source 202 is not particularly limited, but is preferably 100 to 2000 nm and more preferably 380 to 2000 nm.

The lens 204 is used to convert the light emitted from the light source 202 into parallel light and to allow the parallel light to be incident into the optical element 100. The lens 204 is not particularly limited as long as the light emitted from the light source 202 can be converted into parallel light, and a convex lens, a cylindrical lens, or the like can be used.

The light receiver 206 is a sensor that receives the light transmitted through the optical element 100 and performs photoelectric conversion on the received light.

As the sensor 206, a well-known imaging element in the related art such as a charge-coupled device (CCD) image sensor or a complementary metal oxide semiconductor (CMOS) image sensor can be used. In addition, the light receiver 206 may be a line sensor in which a plurality of pixels are arranged in a one-dimensional manner (linearly), or may be a two-dimensional sensor in which a plurality of pixels are arranged in a two-dimensional manner.

The optical sensor 200 having such a configuration can be used as a refractive index sensor that measures a refractive index of an object to be measured.

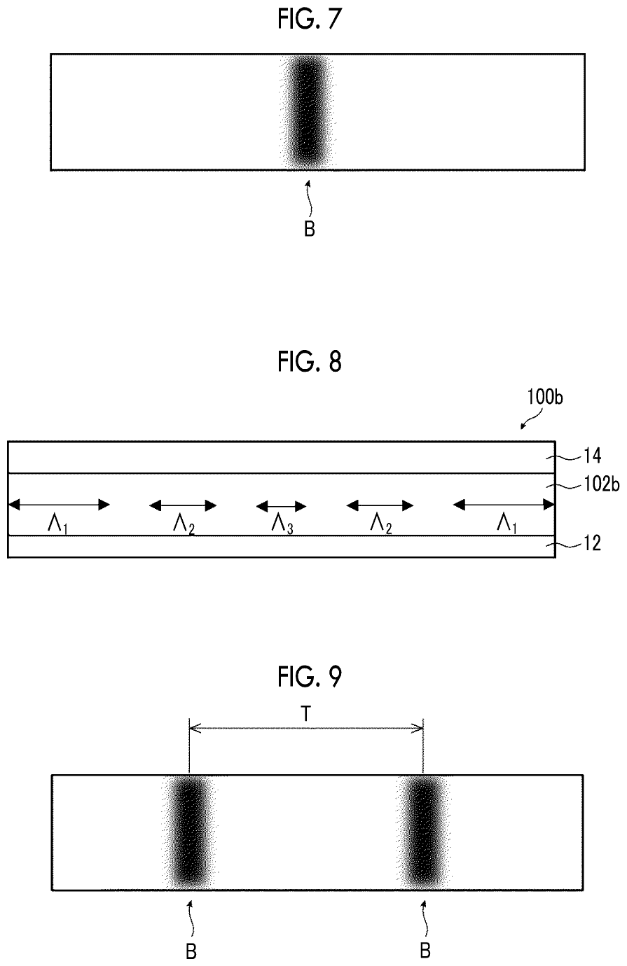

In the optical sensor 200, an object to be measured is disposed on the optical element 100, light having a single wavelength is emitted from the light source 202, the light emitted from the light source 202 is converted into parallel light by the lens 204 to travel in the direction of the optical element 100, and the light is incident on the optical element 100. The optical element 100 reflects light having a single wavelength at a certain position in a plane and transmits light in the other region. The light transmitted through the optical element 100 is received by the light receiver 206. At the position where the optical element 100 reflects light, light is not incident on the light receiver 206. Therefore, in a case where the light received by the light receiver 206 is imaged, for example, as shown in FIG. 7, an image including the black line portion B in a part thereof can be obtained.

As described above, since the position where light is reflected according to the refractive index of the object to be measured disposed on the optical element 100, that is, the position of the black line portion B shifts, the refractive index of the object to be measured can be obtained from the position of the black line portion B of the image obtained as described above by grasping the relationship between the refractive index of the substance disposed on the liquid crystal layer (optical element) in advance and the position of the peak wavelength of the reflected light, that is, the position of the black line portion B.

In particular, the closer the average refractive index of the liquid crystal layer and the refractive index of the object to be measured are to each other, the larger the shift width of the peak wavelength of the reflected light is. Therefore, the refractive index of the object to be measured can be more accurately obtained as the refractive index of the object to be measured is closer to the average refractive index of the liquid crystal layer. In a case where a difference in refractive index between the average refractive index of the liquid crystal layer and the refractive index of the object to be measured is 0.05 to 0.3, the refractive index of the object to be measured can be more accurately obtained.

The average refractive index of the liquid crystal layer refers to the average value of a refractive index in a direction where a refractive index in the in-plane direction of the liquid crystal layer is the highest and a refractive index in a direction orthogonal to the direction in which the refractive index is the highest.

In addition, a material having a predetermined refractive index is disposed on the liquid crystal layer and an incidence angle of incidence light changes, reflected light is detected at a specific incidence angle. Depending on the refractive index of the object to be measured, an angle at which reflected light from the optical sensor according to the embodiment of the present invention reaches the peak is shifted. Using the above-described characteristics, a relationship between the refractive index of a material disposed on the liquid crystal layer and the incidence angle at which the reflected light is detected is grasped in advance, the object to be measured of which the refractive index is not known is disposed on the liquid crystal layer, and an incidence angle at which reflected light is obtained is measured. As a result, the refractive index of the object to be measured can be obtained.

In addition, the optical sensor according to the embodiment of the present invention can also be suitably used as a biochemical sensor or the like.

Further, in addition to the optical sensor, the optical element according to the embodiment of the present invention can also be suitably used as a wavelength selective filter, a polarization separating element, a retardation plate, an optical switch, or the like.

Here, in the examples shown in FIGS. 1 and 6, in the liquid crystal layer 104 of the optical element 100 of the optical sensor 200, the rotation direction in which the orientation of the optical axis derived from the liquid crystal compound continuously rotates along the one direction is set to the constant direction. However, the present invention is not limited thereto. The liquid crystal layer of the optical element may have a liquid crystal alignment pattern in which a rotation direction in which the orientation of the optical axis derived from the liquid crystal compound continuously rotates is reversed with a certain point as a boundary in the direction along the one direction. In other words, the liquid crystal layer may have a liquid crystal alignment pattern in which rotation directions of the optical axes are the same in a case where the liquid crystal layer is viewed in a direction away from a certain point. In this case, it is preferable that the single period A gradually increases (or decreases) in the same direction in the rotation direction.

For example, an optical element 100b shown in FIG. 8 is an example in which the rotation direction of the optical axis in the liquid crystal alignment pattern of the liquid crystal layer 102b is reversed in the one direction from the left side to the right side with respect to the substantially center position. That is, in the liquid crystal alignment pattern of the liquid crystal layer 102b, the rotation direction of the optical axis in a case of being viewed in the direction from the center position in the left-right direction toward the left side is the same as the rotation direction of the optical axis in a case of being viewed in the direction from the center position toward the right side. In the liquid crystal layer 102b, as shown in FIG. 8, the single period A gradually increases in a direction from the center position in the left-right direction to the left side (Λ₃<Λ₂<Λ₁), and the single period A gradually increases in a direction from the center position in the left-right direction to the right side (Λ₃<Λ₂<Λ₁). In addition, in the example shown in FIG. 8, the amount of change of the single period A matches between the right direction and the left direction.

In a case where light having a single wavelength is incident, the optical element 100b including the liquid crystal layer 102b reflects the light at positions having the same length A of the single period and transmits the light in other regions. In a case where an image is acquired by an optical sensor using the optical element 100b including the liquid crystal layer 102b, two black line portions B are observed as shown in FIG. 9. As described above, the position where the optical element reflects light changes depending on the refractive index of the periphery of the liquid crystal layer. Therefore, the interval T between the two black line portions B changes depending on the refractive index of the periphery of the liquid crystal layer. Accordingly, in a case where the optical element 100b is used, the relationship between the refractive index of the substance disposed on the liquid crystal layer (optical element) in advance and the interval T of the black line portion B is grasped in advance, the object to be measured of which the refractive index is unknown is disposed on the liquid crystal layer (optical element), and the interval T of the black line portion B is measured, whereby the refractive index of the object to be measured can be obtained. Such a configuration is preferable from the viewpoint that the refractive index can be detected without specifying an absolute position by measuring the interval between the two black line portions B.

In the example shown in FIG. 8, the liquid crystal layer 102b has the configuration in which the single period A gradually increases in a case of being viewed in the direction from the center position toward the left side and the single period A gradually increases in a case of being viewed in the direction from the center position toward the right side. However, the present invention is not limited to this, and the liquid crystal layer 102b may have a configuration in which the single period A gradually decreases in a case of being viewed in the direction from the center position toward the left side and the single period A gradually decreases in a case of being viewed in the direction from the center position toward the right side.

In addition, in the example shown in FIG. 1, the liquid crystal alignment pattern of the liquid crystal layer is such that the arrangement axis D is present in the one in-plane direction. However, the present invention is not limited thereto, and various configurations can be used as long as the optical axis 40A of the liquid crystal compound 40 in the liquid crystal layer continuously rotates in the one direction.

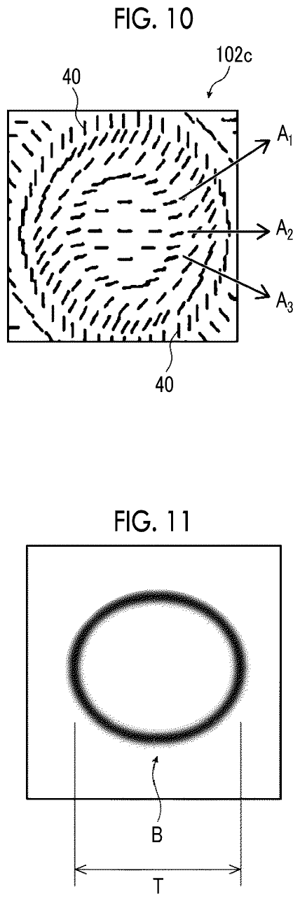

For example, as conceptually shown in the plan view of FIG. 10, the liquid crystal layer 102c may have a configuration in which the liquid crystal alignment pattern is provided in a radial shape. In the liquid crystal layer 102c shown in FIG. 10, the orientation of the optical axis of the liquid crystal compound 40 changes while continuously rotating in a large number of directions moving to the outer side from the center of the liquid crystal layer 102c, for example, a direction indicated by an arrow A₁, a direction indicated by an arrow A₂, a direction indicated by an arrow A₃, or . . . . That is, the arrows A₁, A₂, and A₃ are arrangement axes.

In addition, as shown in FIG. 10, the optical axis of the liquid crystal compound 40 changes while rotating in the same direction from the center of the liquid crystal layer 102c toward the outer side. In the aspect shown in FIG. 10, counterclockwise alignment is shown. The rotation directions in which the optical axes rotate and change along the respective arrows A₁, A₂, and Λ₃ in FIG. 10 are counterclockwise from the center toward the outer side.

In the radial liquid crystal alignment pattern, a line that connects liquid crystal compounds of which optical axes face the same direction has a circular shape, and a circular line segment is a concentric circular pattern.

In the liquid crystal layer 102c having the radial liquid crystal alignment pattern, the single period A may gradually increase (or decrease) from the center toward the outer side along each of the arrangement axes (A₁, A₂, and A₃).

In a case where the optical element including the liquid crystal layer 102c is used for the optical sensor, an image in which a circular black line portion B conceptually shown in FIG. 11 is observed is acquired. In this case, the diameter T of the circular black line portion B changes depending on the refractive index of the periphery of the liquid crystal layer. Accordingly, in a case where the optical element including the liquid crystal layer 102c is used, the refractive index of the object to be measured can be obtained by grasping the relationship between the refractive index of the substance disposed on the liquid crystal layer (optical element) in advance and the diameter T of the black line portion B, disposing the object to be measured, of which the refractive index is unknown, on the liquid crystal layer (optical element), and measuring the diameter T of the black line portion B.

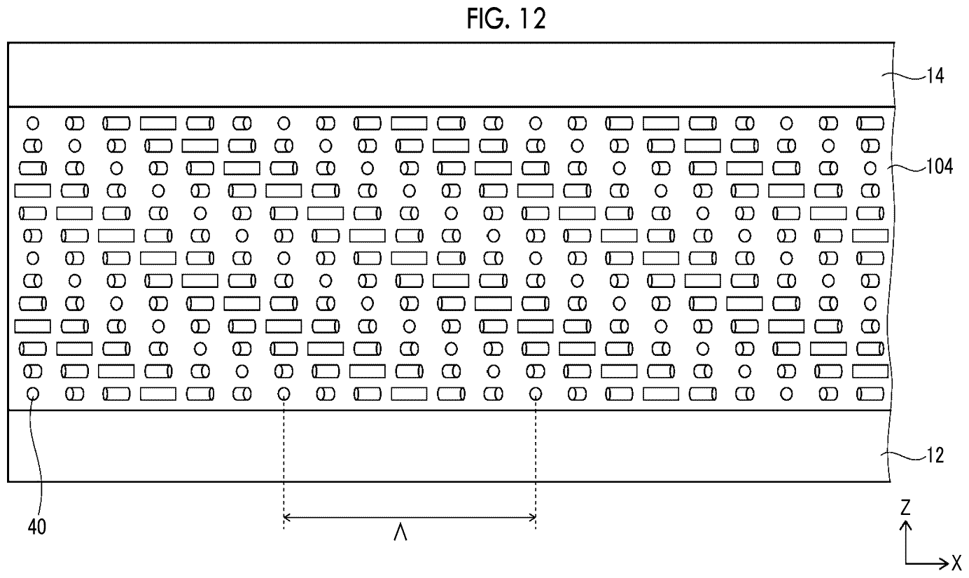

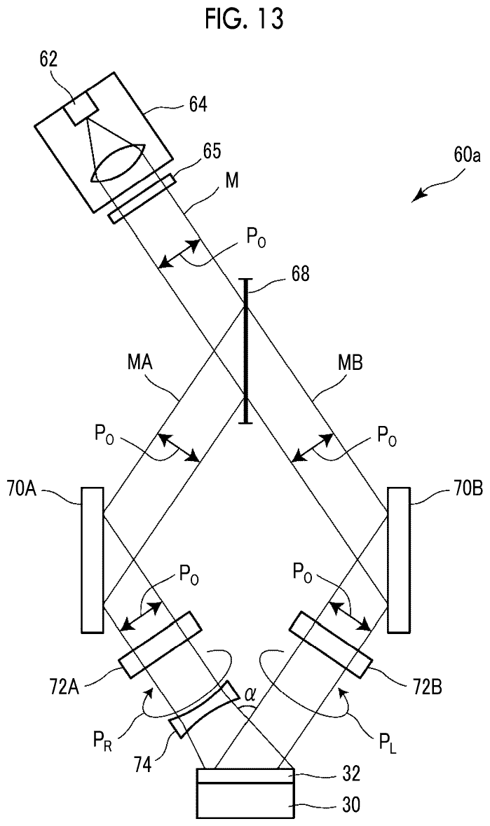

In addition, in the example shown in FIG. 1, in the liquid crystal layer 102, the liquid crystal compound 40 is not helically twisted and rotated in the thickness direction, and the liquid crystal compounds 40 at the same position in the plane direction are aligned such that the directions of the optical axes 40A are the same. However, the present invention is not limited thereto, and the liquid crystal layer may have a region where the optical axis of the liquid crystal compound is twisted in the thickness direction in a plane, and the liquid crystal compound may be cholesterically aligned. That is, the liquid crystal layer 104 may be a cholesteric liquid crystal layer obtained by immobilizing a cholesteric liquid crystalline phase as in the optical element 100c shown in FIG. 12.

The liquid crystal layer 104 of the optical element 100c shown in FIG. 12 has the same configuration as the liquid crystal layer shown in FIGS. 2 and 3 except that the liquid crystal compound is twisted and aligned in the thickness direction. That is, in a case where the liquid crystal layer 104 shown in FIG. 12 is seen from the thickness direction, as in the example shown in FIG. 3, the liquid crystal layer 104 has the liquid crystal alignment pattern in which the orientation of the optical axis 40A changes while continuously rotating along the arrangement axis D in a plane of the liquid crystal layer 104.

In addition, although not shown, in the liquid crystal layer 104, the single period A in the liquid crystal alignment pattern gradually changes along the arrangement axis D.

In addition, the liquid crystal layer 104 is a cholesteric liquid crystal layer formed by immobilizing a cholesteric liquid crystalline phase in which the liquid crystal compound 40 is turned and laminated in a thickness direction. By using the liquid crystal layer 104 as a cholesteric liquid crystal layer, the reflection wavelength range can be narrowed in the optical element that selectively reflects light in a specific wavelength range by causing a guided-mode resonance phenomenon using the liquid crystal layer.

As is well known, the cholesteric liquid crystal layer has wavelength-selective reflectivity, reflects light having a specific wavelength, and transmits light having other wavelengths. Therefore, the helical pitch in the liquid crystal layer 104 is set such that the selective reflection wavelength is a wavelength different from the wavelength of the light emitted from the light source in a case where the optical element 100c is used as an optical sensor, so that the liquid crystal layer 104 does not reflect the light having the wavelength reflected by the guided-mode resonance phenomenon due to the action of the cholesteric liquid crystalline phase.

A helical pitch of the cholesteric liquid crystalline phase of the liquid crystal layer 104 is preferably 0.1 μm to 0.9 μm, more preferably 0.1 μm to 0.8 μm, and still more preferably 0.2 μm to 0.7 μm.

As is well known, the cholesteric liquid crystalline phase has a helical structure in which the liquid crystal compound 40 is twisted and aligned, and laminated in the thickness direction. In the helical structure, a configuration in which the liquid crystal compound 40 is helically rotated once (rotated by 360) is set as one helical pitch (pitch P), and plural pitches of the helically turned liquid crystal compounds 40 are laminated.

Among these, the number of helical pitches is preferably 3 to 8.

In the present specification, the number of helical pitches refers to the number of helical pitches (number of turns) of a helical structure derived from a cholesteric liquid crystalline phase in the liquid crystal layer.

In the present invention, specifically, the cholesteric liquid crystalline phase refers to a phase where the twisted angle of the liquid crystal compound 40 in the liquid crystal layer is 360° or more.

As is well known, the cholesteric liquid crystalline phase exhibits selective reflectivity with respect to any of left circularly polarized light or right circularly polarized light at a specific wavelength depending on the pitch P and the helical twisted direction of the liquid crystal compound 40. Specifically, as the helical pitch P increases, the wavelength of light to be selectively reflected increases. In addition, in a case where the helical twisted direction of the liquid crystal compound 40 is right, right circularly polarized light is selectively reflected, and in a case where the helical twisted direction of the liquid crystal compound 40 is left, left circularly polarized light is selectively reflected. In addition, the cholesteric liquid crystalline phase allows transmission of light other than the light to be selectively reflected.

The number of helical pitches of the liquid crystal compound 40 in the liquid crystal layer 104 can be adjusted by the type and an amount of the chiral agent to be added to the liquid crystal composition described below.

In addition, the twisted direction of the cholesteric alignment of the liquid crystal compound 40 in the liquid crystal layer 104 can be selected from the type of the liquid crystal compound to be added to the liquid crystal composition described below, and/or the type of the chiral agent, or the like.

In the present invention, the twisted direction (helical turning direction) of the cholesteric alignment of the liquid crystal compound 40 in the liquid crystal layer 104 is not limited and may be right-handed or left-handed.

As described above, in order to adopt the configuration in which the liquid crystal compound is twisted and aligned in the thickness direction of the liquid crystal layer, the liquid crystal composition for forming the liquid crystal layer may contain a chiral agent described below.

The liquid crystal layer 104 can be formed by immobilizing a liquid crystalline phase in a layer shape, the liquid crystalline phase obtained by aligning the liquid crystal compound in a predetermined alignment state.

The structure in which a liquid crystalline phase is immobilized may be a structure in which the alignment of the liquid crystal compound as a liquid crystalline phase is maintained. Typically, it is preferable that the structure in which a liquid crystalline phase is immobilized is a structure which is obtained by making the polymerizable liquid crystal compound to be in a state where a predetermined liquid crystalline phase is aligned, by polymerizing and curing the polymerizable liquid crystal compound with ultraviolet irradiation, heating, or the like to form a layer having no fluidity, and by concurrently changing the state of the polymerizable liquid crystal compound into a state where the alignment state is not changed by an external field or an external force.

It is sufficient that the structure in which a liquid crystalline phase is immobilized has the optical characteristics of the liquid crystalline phase maintained, and the liquid crystal compound 40 in the liquid crystal layer does not necessarily exhibit liquid crystallinity. For example, the molecular weight of the polymerizable liquid crystal compound may be increased by a curing reaction such that the liquid crystallinity thereof is lost.

### <Liquid Crystal Composition for Forming Liquid Crystal Layer>

Examples of a material used for forming the liquid crystal layer include a liquid crystal composition including a liquid crystal compound. It is preferable that the liquid crystal compound is a polymerizable liquid crystal compound.

In addition, the liquid crystal composition used for forming the liquid crystal layer may further include a surfactant and a chiral agent.

### —Polymerizable Liquid Crystal Compound—

The polymerizable liquid crystal compound may be a rod-like liquid crystal compound or a disk-like liquid crystal compound.

Examples of the rod-like polymerizable liquid crystal compound include a rod-like nematic liquid crystal compound. As the rod-like nematic liquid crystal compounds, azomethine compounds, an azoxy compounds, cyanobiphenyl compounds, cyanophenyl ester compounds, benzoate ester compounds, phenyl cyclohexanecarboxylate ester compounds, cyanophenylcyclohexane compounds, cyano-substituted phenylpyrimidine compounds, alkoxy-substituted phenylpyrimidine compounds, phenyldioxane compounds, tolan compounds, or alkenylcyclohexylbenzonitrile compounds are preferably used. Not only a low-molecular-weight liquid crystal compound but also a polymer liquid crystal compound can be used.

The polymerizable liquid crystal compound can be obtained by introducing a polymerizable group into the liquid crystal compound. Examples of the polymerizable group include an unsaturated polymerizable group, an epoxy group, and an aziridinyl group. Among these, an unsaturated polymerizable group is preferable, and an ethylenically unsaturated polymerizable group is more preferable. The polymerizable group can be introduced into the molecules of the liquid crystal compound using various methods. The number of polymerizable groups in the polymerizable liquid crystal compound is preferably 1 to 6 and more preferably 1 to 3.

Examples of the polymerizable liquid crystal compound include compounds described in Makromol. Chem., (1989), Vol. 190, p. 2255, Advanced Materials (1993), Vol. 5, p. 107, U.S. Pat. Nos. 4,683,327A, 5,622,648A, 5,770,107A, WO95/022586, WO95/024455, WO97/000600, WO98/023580, WO98/052905, JP1989-272551A (JP-H1-272551A), JP1994-16616A (JP-H6-16616A), JP1995-110469A (JP-H7-110469A), JP1999-80081A (JP-H11-80081A), and JP2001-328973A. Two or more polymerizable liquid crystal compounds may be used in combination. In a case where two or more polymerizable liquid crystal compounds are used in combination, the alignment temperature can be decreased.

In addition, as a polymerizable liquid crystal compound other than the above-described examples, for example, a cyclic organopolysiloxane compound disclosed in JP1982-165480A (JP-S57-165480A) can be used. Further, as the above-described polymer liquid crystal compound, for example, a polymer in which a liquid crystal mesogenic group is introduced into a main chain, a side chain, or both a main chain and a side chain, a polymer cholesteric liquid crystal in which a cholesteryl group is introduced into a side chain, a liquid crystal polymer disclosed in JP1997-133810A (JP-H9-133810A), and a liquid crystal polymer disclosed in JP1999-293252A (JP-H11-293252A) can be used.

### —Disk-Like Liquid Crystal Compound—

As the disk-like liquid crystal compound, for example, compounds described in JP2007-108732A and JP2010-244038A can be preferably used.

In addition, the addition amount of the polymerizable liquid crystal compound in the liquid crystal composition is preferably 75 to 99.9 mass %, more preferably 80 to 99 mass %, and still more preferably 85 to 90 mass % with respect to the solid content mass (mass excluding a solvent) of the liquid crystal composition.

### —Surfactant—

The liquid crystal composition used for forming the liquid crystal layer may include a surfactant.

It is preferable that the surfactant is a compound that can function as an alignment control agent contributing to the stable or rapid alignment of the liquid crystal compound 40 in the liquid crystal layer 102. Examples of the surfactant include a silicone-based surfactant and a fluorine-based surfactant. Among these, a fluorine-based surfactant is preferable.

Specific examples of the surfactant include compounds described in paragraphs “0082” to “0090” of JP2014-119605A, compounds described in paragraphs “0031” to “0034” of JP2012-203237A, exemplary compounds described in paragraphs “0092” and “0093” of JP2005-99248A, exemplary compounds described in paragraphs “0076” to “0078” and paragraphs “0082” to “0085” of JP2002-129162A, and fluorine (meth)acrylate polymers described in paragraphs “0018” to “0043” of JP2007-272185A.

The surfactants may be used alone or in combination of two or more kinds.

As the fluorine-based surfactant, a compound described in paragraphs “0082” to “0090” of JP2014-119605A is preferable.

The addition amount of the surfactant in the liquid crystal composition is preferably 0.01 to 10 mass %, more preferably 0.01 to 5 mass %, and still more preferably 0.02 to 1 mass % with respect to the total mass of the liquid crystal compound.

### —Chiral Agent (Optically Active Compound)—

The chiral agent has a function of inducing the twisted alignment of the liquid crystal compound in the thickness direction. The chiral agent may be selected depending on the purpose because a twisted direction or a twisted angle derived from the compound varies.

The chiral agent is not particularly limited. For example, a well-known compound, an isosorbide, or an isomannide derivative can be used. Examples of the well-known compound include compounds described in “Liquid Crystal Device Handbook (No. 142 Committee of Japan Society for the Promotion of Science, 1989), Chapter 3, Article 4-3, chiral agent for twisted nematic (TN) or super twisted nematic (STN), p. 199”.

In general, the chiral agent includes a chiral carbon atom. However, an axially chiral compound or a planar chiral compound not having a chiral carbon atom can also be used as the chiral agent. Examples of the axially chiral compound or the planar chiral compound include binaphthyl, helicene, paracyclophane, and derivatives thereof. The chiral agent may include a polymerizable group. In a case where both the chiral agent and the liquid crystal compound have a polymerizable group, a polymer which includes a repeating unit derived from the polymerizable liquid crystal compound and a repeating unit derived from the chiral agent can be formed by a polymerization reaction of a polymerizable chiral agent and the polymerizable liquid crystal compound. In this aspect, it is preferable that the polymerizable group in the polymerizable chiral agent is the same as the polymerizable group in the polymerizable liquid crystal compound. Accordingly, the polymerizable group of the chiral agent is preferably an unsaturated polymerizable group, an epoxy group, or an aziridinyl group, more preferably an unsaturated polymerizable group, and still more preferably an ethylenically unsaturated polymerizable group.

In addition, the chiral agent may be a liquid crystal compound.

In a case where the chiral agent includes a photoisomerization group, a pattern having a desired reflection wavelength corresponding to a luminescence wavelength can be formed by irradiation of an actinic ray or the like through a photo mask after coating and alignment, which is preferable. As the photoisomerization group, an isomerization portion of a photochromic compound, an azo group, an azoxy group, or a cinnamoyl group is preferable. Specific examples of the compound include compounds described in JP2002-80478A, JP2002-80851A, JP2002-179668A, JP2002-179669A, JP2002-179670A, JP2002-179681A, JP2002-179682A, JP2002-338575A, JP2002-338668A, JP2003-313189A, and JP2003-313292A.

As described above, in the liquid crystal layer, the twisted angle of the liquid crystal compound in the thickness direction can be adjusted based on the amount of the chiral agent.

Accordingly, the content of the chiral agent in the liquid crystal composition may be appropriately set depending on the desired twisted angle of the liquid crystal compound 40 in the thickness direction.

### —Polymerization Initiator—

In a case where the liquid crystal composition includes a polymerizable compound, it is preferable that the liquid crystal composition includes a polymerization initiator. In an aspect where a polymerization reaction progresses with ultraviolet irradiation, it is preferable that the polymerization initiator to be used is a photopolymerization initiator which initiates a polymerization reaction with ultraviolet irradiation.

Examples of the photopolymerization initiator include an α-carbonyl compound (described in U.S. Pat. Nos. 2,367,661A and 2,367,670A), an acyloin ether (described in U.S. Pat. No. 2,448,828A), an α-hydrocarbon-substituted aromatic acyloin compound (described in U.S. Pat. No. 2,722,512A), a polynuclear quinone compound (described in U.S. Pat. Nos. 3,046,127A and 2,951,758A), a combination of a triarylimidazole dimer and p-aminophenyl ketone (described in U.S. Pat. No. 3,549,367A), an acridine compound and a phenazine compound (described in JP1985-105667A (JP-S60-105667A) and U.S. Pat. No. 4,239,850A), and an oxadiazole compound (described in U.S. Pat. No. 4,212,970A).

The content of the photopolymerization initiator in the liquid crystal composition is preferably 0.1 to 20 mass % and more preferably 0.5 to 12 mass % with respect to the content of the liquid crystal compound.

### —Crosslinking Agent—

In order to improve the film hardness after curing and to improve durability, the liquid crystal composition may optionally include a crosslinking agent. As the crosslinking agent, a curing agent which can perform curing with ultraviolet light, heat, moisture, or the like can be suitably used.

The crosslinking agent is not particularly limited and can be appropriately selected depending on the purpose. Examples of the crosslinking agent include: a polyfunctional acrylate compound such as trimethylol propane tri (meth)acrylate or pentaerythritol tri(meth)acrylate; an epoxy compound such as glycidyl (meth)acrylate or ethylene glycol diglycidyl ether; an aziridine compound such as 2,2-bis hydroxymethyl butanol-tris [3-(1-aziridinyl) propionate] or 4,4-bis(ethyleneiminocarbonylamino)diphenylmethane; an isocyanate compound such as hexamethylene diisocyanate or a biuret type isocyanate; a polyoxazoline compound having an oxazoline group at a side chain thereof; and an alkoxysilane compound such as vinyl trimethoxysilane or N-(2-aminoethyl)-3-aminopropyltrimethoxysilane. In addition, depending on the reactivity of the crosslinking agent, a well-known catalyst can be used, and not only film hardness and durability but also productivity can be improved. The crosslinking agents may be used alone or in combination of two or more kinds.

The content of the crosslinking agent is preferably 3 to 20 mass % and more preferably 5 to 15 mass % with respect to the solid content mass of the liquid crystal composition. In a case where the content of the crosslinking agent is in the above-described range, an effect of improving a crosslinking density can be easily obtained, and the stability of a liquid crystalline phase is further improved.

### —Other Additives—

Optionally, a polymerization inhibitor, an antioxidant, an ultraviolet absorber, a light stabilizer, a coloring material, metal oxide fine particles, or the like can be further added to the liquid crystal composition in a range where optical performance and the like do not deteriorate.

In a case where the liquid crystal layer 102 is formed, it is preferable that the liquid crystal composition is used as liquid.

The liquid crystal composition may include a solvent. The solvent is not particularly limited and can be appropriately selected depending on the purpose. An organic solvent is preferable.

The organic solvent is not particularly limited and can be appropriately selected depending on the purpose. Examples of the organic solvent include a ketone, an alkyl halide, an amide, a sulfoxide, a heterocyclic compound, a hydrocarbon, an ester, and an ether. The crosslinking agents may be used alone or in combination of two or more kinds. Among these, in consideration of environmental load, ketones are preferable.

In a case where the liquid crystal layer is formed, it is preferable that the liquid crystal layer is formed by applying the liquid crystal composition to a surface where the liquid crystal layer is to be formed, aligning the liquid crystal composition to a state of a desired liquid crystalline phase, and curing the liquid crystal compound.

That is, in a case where the liquid crystal layer is formed on the alignment film described below, it is preferable that the liquid crystal layer is formed by applying the liquid crystal composition to the alignment film, twisting and aligning the liquid crystal compound, and curing the liquid crystal compound.

For the application of the liquid crystal composition, a printing method such as ink jet or scroll printing or a well-known method such as spin coating, bar coating, or spray coating capable of uniformly applying liquid to a sheet-shaped material can be used.

The applied liquid crystal composition is optionally dried and/or heated and then cured to form the liquid crystal layer. In the drying and/or heating step, the liquid crystal compound 40 in the liquid crystal composition may be twisted and aligned. In the case of heating, the heating temperature is preferably 200° C. or lower and more preferably 130° C. or lower.

The aligned liquid crystal compound is optionally further polymerized. Regarding the polymerization, thermal polymerization or photopolymerization using light irradiation may be performed, and photopolymerization is preferable. Regarding the light irradiation, ultraviolet ray is preferably used. The irradiation energy is preferably 20 mJ/cm² to 50 J/cm² and more preferably 50 mJ/cm² to 1500 mJ/cm². In order to promote a photopolymerization reaction, light irradiation may be performed under heating conditions or in a nitrogen atmosphere. The wavelength of irradiated ultraviolet light is preferably 250 to 430 nm.

### <Alignment Film>

As the alignment film, various well-known films can be used as long as they can align the liquid crystal compound.

Examples of the alignment film include a rubbed film formed of an organic compound such as a polymer, an obliquely deposited film formed of an inorganic compound, a film having a microgroove, and a film formed by lamination of Langmuir-Blodgett (LB) films formed with a Langmuir-Blodgett's method using an organic compound such as ω-tricosanoic acid, dioctadecylmethylammonium chloride, or methyl stearate.

The alignment film formed by a rubbing treatment can be formed by rubbing a surface of a polymer layer with paper or fabric in a given direction multiple times.

As the material used for the alignment film, for example, a material for forming polyimide, polyvinyl alcohol, a polymer having a polymerizable group described in JP1997-152509A (JP-H9-152509A), or an alignment film such as JP2005-97377A, JP2005-99228A, and JP2005-128503A is preferable.

The alignment film can be suitably used as a so-called photo-alignment film obtained by irradiating a photo-alignment material with polarized light or non-polarized light. That is, a photo-alignment film that is formed by applying a photo-alignment material to a substrate is suitably used as the alignment film.

The irradiation of the polarized light can be performed in a direction perpendicular or oblique to the photo-alignment film, and the irradiation of non-polarized light can be performed in a direction oblique to the photo-alignment film.

Preferable examples of the photo-alignment material used in the alignment film that can be used in the present invention include: an azo compound described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B; an aromatic ester compound described in JP2002-229039A; a maleimide- and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, a photocrosslinking polyamide, or a photocrosslinking polyester described in JP2003-520878A, JP2004-529220A, and JP4162850B; and a photodimerizable compound, in particular, a cinnamate compound, a chalcone compound, or a coumarin compound described in JP1997-118717A (JP-H9-118717A), JP1998-506420A (JP-H10-506420A), JP2003-505561A, WO2010/150748A, JP2013-177561A, and JP2014-12823A.

Among these, an azo compound, a photocrosslinking polyimide, a photocrosslinking polyamide, a photocrosslinking polyester, a cinnamate compound, or a chalcone compound is suitably used.

A thickness of the alignment film is not particularly limited. The thickness with which a required alignment function can be obtained may be appropriately set depending on the material for forming the alignment film.

A method of forming the alignment film is not limited. Any one of various well-known methods corresponding to a material for forming the alignment film can be used. Examples thereof include a method including: applying the alignment film to a surface of a substrate; drying the applied alignment film; and exposing the alignment film to laser light to form an alignment pattern.

FIG. 13 conceptually shows an example of an exposure device that exposes the alignment film to form an alignment pattern. FIG. 13 shows an example where an alignment film 32 formed on a surface of a support 30 is exposed.

An exposure device 60a shown in FIG. 13 comprises a light source 64 that comprises a laser 62, a λ/2 plate 65 that changes a polarization direction of laser light M emitted from the laser 62, a polarization beam splitter 68 that splits the laser light M emitted from the laser 62 into two beams MA and MB, mirrors 70A and 70B that are disposed on optical paths of the two split beams MA and MB, λ/4 plates 72A and 72B, and a lens 74 that is disposed on the optical path of one beam MA.

The light source 64 emits linearly polarized light P₀. The λ/4 plate 72A converts the linearly polarized light P₀ (beam MA) into right circularly polarized light P_{R}, and the λ/4 plate 72B converts the linearly polarized light P₀ (beam MB) into left circularly polarized light P_{L}. In addition, the lens 74 is a concave lens that diverges light, and diverges right circularly polarized light P_{R} that is parallel light.

The alignment film 32 on which the alignment pattern is not yet formed is disposed at an exposure position, the two beams MA and MB intersect and interfere with each other on the alignment film, and the alignment film 32 is irradiated with and exposed to the interference light.

Due to the interference in this case, the polarization state of light with which the alignment film is irradiated periodically changes according to interference fringes. As a result, an alignment film having an alignment pattern in which the alignment state periodically changes can be obtained. In the following description, this alignment film having the alignment pattern will also be referred to as “patterned alignment film”.

In the exposure device 60a, by changing an intersecting angle α between the two beams MA and MB, the period of the alignment pattern can be adjusted. That is, by adjusting the intersecting angle α in the exposure device 60a, in the alignment pattern in which the optical axis 40A derived from the liquid crystal compound 40 continuously rotates in the one direction, the length of the single period over which the optical axis 40A rotates by 180° in the one direction in which the optical axis 40A rotates can be adjusted.

Further, by using the lens 74 to diverge one of the two beams MA and MB, the intersection angle α between the beams MA and MB that interfere with each other on the alignment film changes in a plane. Therefore, the length of the single period in the alignment pattern can be changed in the plane.

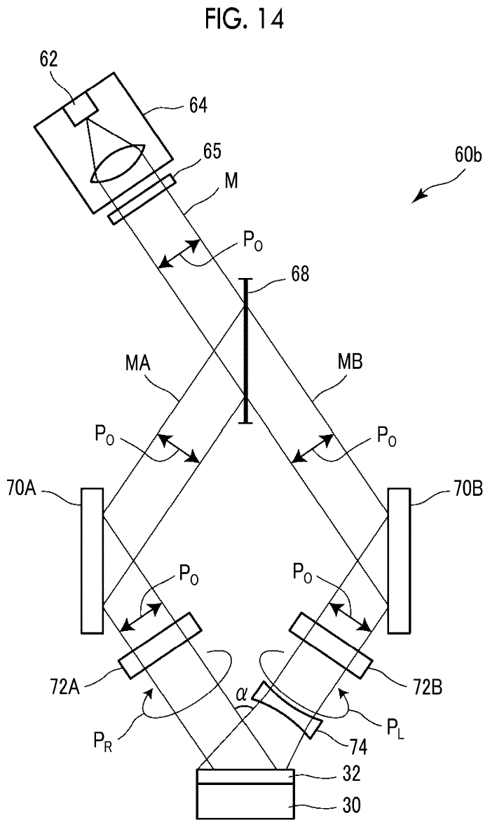

In the example shown in FIG. 13, the lens 74 is disposed on the optical path of the ray MA, but the present invention is not limited thereto. As in the exposure device 60b shown in FIG. 14, the lens 74 may be disposed on the optical path of the ray MB. The direction in which the length of the single period increases can be set by disposing the lens 74 on the optical path of the ray MA or disposing the lens 74 on the optical path of the ray MB. For example, in the example shown in FIG. 13, the intersecting angle between the two beams of the interference exposure on the alignment film 32 increases at the right end of the alignment film 32, and the length of the single period decreases. Therefore, the length of the single period decreases from the left end to the right end of the alignment film 32. On the other hand, in the example shown in FIG. 14, the length of the single period decreases from the right end to the left end of the alignment film 32.

In addition, in the example shown in FIG. 13, the lens 74 is a concave lens, but the present invention is not limited to this, and a convex lens may be used. In either case where the lens 74 is the concave lens or the convex lens, the intersecting angle α between the rays MA and the rays MB that interfere with each other on the alignment film can be changed in a plane in order to convert the rays into non-parallel light.

By forming the liquid crystal layer 102 on the alignment film having the alignment pattern in which the alignment state periodically changes, as described above, the liquid crystal layer having the liquid crystal alignment pattern in which the optical axis of the liquid crystal compound continuously rotates in the one direction can be formed.

In addition, by rotating the optical axes of the λ/4 plates 72A and 72B by 90°, respectively, a rotation direction of the optical axis 40A can be reversed.

As described above, the patterned alignment film has a liquid crystal alignment pattern in which the liquid crystal compound is aligned such that the orientation of the optical axis of the liquid crystal compound in the liquid crystal layer formed on the patterned alignment film changes while continuously rotating toward at least one direction of in-plane directions.

In a case where an axis in the direction in which the liquid crystal compound is aligned is an alignment axis, it can be said that the patterned alignment film has an alignment pattern in which the direction of the alignment axis changes while continuously rotating toward at least one direction of in-plane directions. The alignment axis of the patterned alignment film can be detected by measuring absorption anisotropy. For example, in a case where the amount of light transmitted through the patterned alignment film is measured by irradiating the patterned alignment film with linearly polarized light while rotating the patterned alignment film, it is observed that a direction in which the light amount is the maximum or the minimum gradually changes in the one in-plane direction.

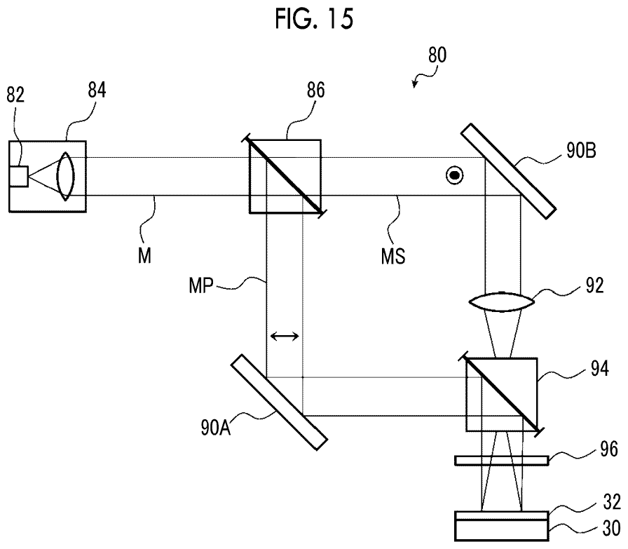

In addition, FIG. 15 shows an example of an exposure device that forms the radial liquid crystal alignment pattern shown in FIG. 10.

An exposure device 80 shown in FIG. 15 includes: a light source 84 that includes a laser 82; a polarization beam splitter 86 that splits the laser light M emitted from the laser 82 into S polarized light MS and P polarized light MP; a mirror 90A that is disposed on an optical path of the P polarized light MP; a mirror 90B that is disposed on an optical path of the S polarized light MS; a lens 92 that is disposed on the optical path of the S polarized light MS; a polarization beam splitter 94; and a λ/4 plate 96.

The P polarized light MP that is split by the polarization beam splitter 86 is reflected from the mirror 90A to be incident into the polarization beam splitter 94. On the other hand, the S polarized light MS that is split by the polarization beam splitter 86 is reflected from the mirror 90B and is collected by the lens 92 to be incident into the polarization beam splitter 94.

The P polarized light MP and the S polarized light MS are combined by the polarization beam splitter 94, are converted into right circularly polarized light and left circularly polarized light by the λ/4 plate 96 depending on the polarization direction, and are incident into the alignment film 32 on the support 30.

Here, due to interference between the right circularly polarized light and the left circularly polarized light, the polarization state of light with which the alignment film 32 is irradiated periodically changes according to interference fringes. The intersecting angle between the right circularly polarized light and the left circularly polarized light changes from the inner side to the outer side of the concentric circle. Therefore, an exposure pattern in which the period changes from the inner side toward the outer side can be obtained. As a result, in the alignment film 32, the radial alignment pattern in which the alignment state periodically changes can be obtained.

In the exposure device 80, the length Λ of the single period in the liquid crystal alignment pattern in which the optical axis of the liquid crystal compound 40 continuously rotates by 180° can be controlled by changing the refractive power of the lens 92 (the F number of the lens 92), the focal length of the lens 92, the distance between the lens 92 and the alignment film 32, and the like.

In addition, by adjusting the refractive power of the lens 92 (the F number of the lens 92), the length Λ of the single period in the liquid crystal alignment pattern in the one direction in which the optical axis continuously rotates can be changed. Specifically, the length Λ of the single period in the liquid crystal alignment pattern in the one direction in which the optical axis continuously rotates can be changed depending on a light spread angle at which light is spread by the lens 92 due to interference with parallel light. More specifically, in a case where the refractive power of the lens 92 is weak, light is approximated to parallel light. Therefore, the length Λ of the single period in the liquid crystal alignment pattern gradually decreases from the inner side toward the outer side. Conversely, in a case where the refractive power of the lens 92 becomes stronger, the length Λ of the single period in the liquid crystal alignment pattern rapidly decreases from the inner side toward the outer side.

Hereinabove, the optical element and the optical sensor according to the embodiment of the present invention have been described in detail. However, the present invention is not limited to the above-described examples, and various improvements and modifications can be made within a range not departing from the scope of the present invention.

### EXAMPLES

Hereinafter, the characteristics of the present invention will be described in detail using examples.

Materials, chemicals, used amounts, material amounts, ratios, treatment details, treatment procedures, and the like shown in the following examples can be appropriately changed within a range not departing from the scope of the present invention. Accordingly, the scope of the present invention is not limited to the following specific examples.

### Example 1

### <Preparation of Liquid Crystal Layer>

### (Formation of Alignment Film)

A glass substrate (EAGLE, manufactured by Corning Inc.) was prepared as a support substrate. The following coating liquid for forming an alignment film was applied to the support by spin coating. The support on which the coating film of the coating liquid for forming an alignment film was formed was dried using a hot plate at 60° C. for 60 seconds. As a result, an alignment film P-2 was formed.

Coating Liquid for forming Alignment Film

| | | |
|---|---|---|
| The following material for photo-alignment | 1.00 | part by mass |
| Water | 16.00 | parts by mass |
| Butoxyethanol | 42.00 | parts by mass |
| Propylene glycol monomethyl ether | 42.00 | parts by mass |

### Material for Photo-Alignment

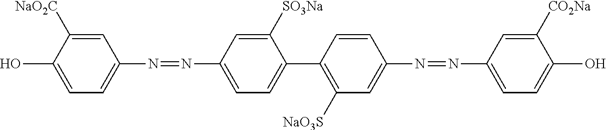

### (Exposure of Alignment Film)

By irradiating the obtained alignment film P-2 with polarized ultraviolet light (50 mJ/cm², using an ultra-high pressure mercury lamp), the alignment film P-2 was exposed.

The alignment film was exposed using the exposure device shown in FIG. 13 to form the alignment film P-2 having an alignment pattern. In the exposure device, a laser that emits laser light having a wavelength (325 nm) was used as the laser. The exposure amount of the interference light was 300 mJ/cm². The intersection angle between the two laser beams was adjusted using a lens such that the single period A (the length over which the optical axis rotates by) 180° of the alignment pattern formed by the interference of the two laser beams continuously changed from 404 μm to 406 μm over a distance of 5 mm in the arrangement axis direction. The rate of change with respect to the distance x of the single period A, that is, |Λ_{X}−Λ₁|/x is 4×10⁻⁴.

### (Formation of Liquid Crystal Layer)

As the liquid crystal composition forming the liquid crystal layer, the following composition B-3 was prepared.

Composition B-3

| | | |
|---|---|---|
| Rod-like liquid crystal compound L-1 | 10.00 | parts by mass |
| Rod-like liquid crystal compound L-2 | 90.00 | parts by mass |
| Polymerization initiator (IRGACURE OXE01, | 1.00 | part by mass |
| manufactured by BASF SE) | | |
| Leveling agent T-1 | 0.08 | parts by mass |
| Methyl ethyl ketone | 4000.00 | parts by mass |

Rod-like liquid crystal compound L-1 (including the following structures at a mass ratio shown on the right side)

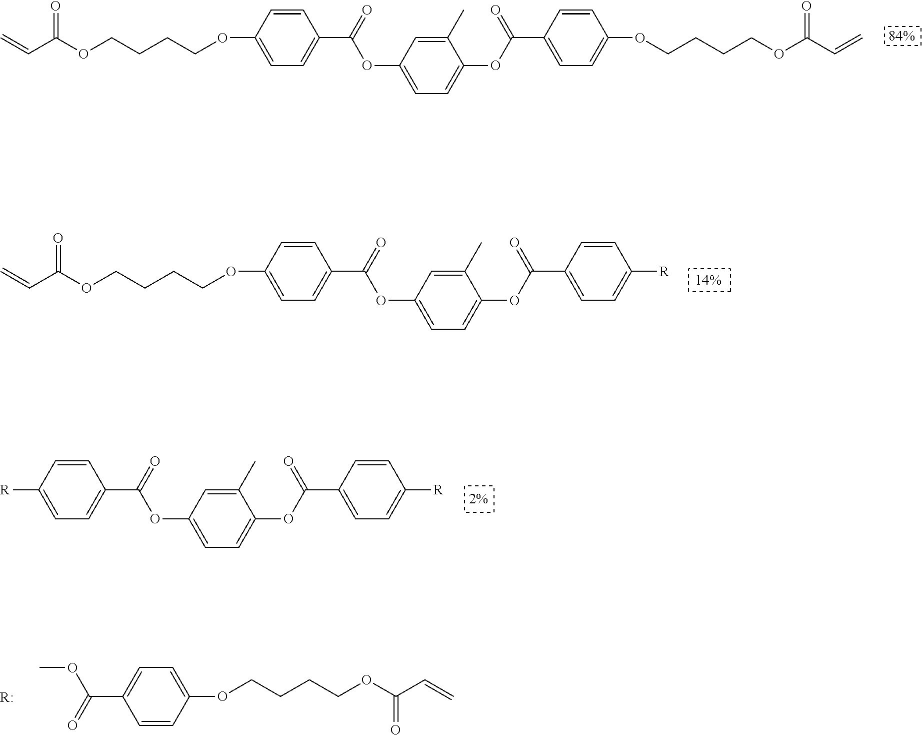

### Rod-Like Liquid Crystal Compound L-2

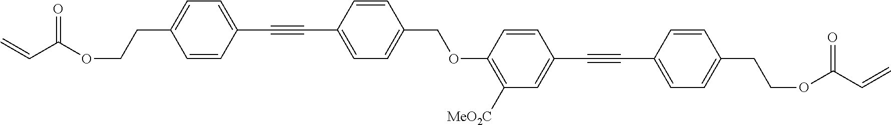 [SMILES: C=CC(=O)OCCc1ccc(C#Cc2ccc(COc3ccc(C#Cc4ccc(CCOC(=O)C=C)cc4)cc3C(=O)OC)cc2)cc1]

### Leveling Agent T-1

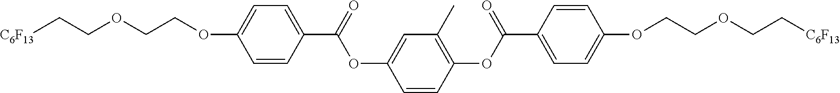

The liquid crystal layer was formed by applying multiple layers of the composition B-3 to the alignment film P-2. The following processes were repeated, the processes including: first preparing a liquid crystal immobilized layer by applying the composition B-3 for forming a first layer to the alignment film, heating the composition B-3, cooling the composition B-3, and irradiating the composition B-3 with ultraviolet ray for curing; and applying the composition B-3 to the liquid crystal immobilized layer in a superimposed manner, heating the composition B-3 in the same manner, cooling the composition B-3, and irradiating the composition B-3 with ultraviolet ray for curing, for forming a second or subsequent layer.

Regarding the first immobilized liquid crystal layer, the above composition B-3 was applied to the alignment film P-2 to form a coating film, the coating film was heated using a hot plate at 80° C., and the coating film was irradiated with ultraviolet light having a wavelength of 365 nm at an irradiation dose of 300 mJ/cm² using a high pressure mercury lamp in a nitrogen atmosphere at 80° C. As a result, the alignment of the liquid crystal compound was immobilized.

Regarding the second or subsequent liquid crystal immobilized layer, the composition was applied to the first liquid crystal layer, and the applied composition was heated, cooled, and irradiated with ultraviolet ray for curing under the same conditions as described above. As a result, a liquid crystal immobilized layer was prepared. In this way, by repeating the application multiple times until the total thickness reached a desired film thickness, the liquid crystal layer was formed.

A difference Δn in refractive index of the cured layer of a liquid crystal composition B-3 was obtained by applying the liquid crystal composition B-3 on a support with an alignment film for retardation measurement that was prepared separately, aligning the director of the liquid crystal compound to be parallel to the substrate, irradiating the liquid crystal compound with ultraviolet irradiation for immobilization to obtain a liquid crystal immobilized layer, and measuring the retardation Re(λ) and the film thickness of the liquid crystal immobilized layer. Ana can be calculated by dividing the retardation Re(λ) by the film thickness. The retardation Re(λ) was measured by measuring a desired wavelength using Axoscan (manufactured by Axometrix inc.) and measuring the film thickness using a scanning electron microscope (SEM). In addition, a refractive index ne (λ) with respect to extraordinary light and a refractive index no (λ) with respect to ordinary light were measured using an Abbe refractometer. In addition, the refractive index anisotropy Δn(λ) was obtained from the difference between ne(λ) and no(λ). In the notations of Re(λ), ne(λ), no(λ), and Δn(λ), λ is a wavelength of incidence light. In the following description, the wavelength λ of incidence light was 633 nm.

Regarding the liquid crystal layer, the final film thickness was 1.68 μm, ne(633) was 1.791, no(633) was 1.565, Δn(633) was 0.227, and it was verified with a microscope that the length of the single period changed in a plane. In addition, the twisted angle of the liquid crystal layer in the thickness direction was 0°. In addition, in a cross sectional image with a SEM, bright and dark lines that were perpendicular to the lower interface (interface with the glass substrate) of the liquid crystal layer were observed, and the interval between the bright and dark lines changed in a plane. The bright and dark lines were observed with the configuration where the liquid crystal compounds aligned in the same direction were laminated in the thickness direction.

A certified refractive index liquid (Certified Refractive index liquids, refractive index: 1.510, manufactured by Cargille Lab) was applied to the liquid crystal layer, and the layer thereof was laminated on the glass substrate of the cover substrate such that air bubbles do not enter the layer. The thickness of the layer of the certified refractive index liquid was 100 μm. In this way, an optical element was prepared to obtain a sample A. Similarly, a sample in which the refractive index of the standard refraction solution was changed to 1.520 was also prepared and used as a sample B.

### [Evaluation]

Collimated laser light (wavelength: 633 nm) was incident into the prepared optical element, and the transmitted light was measured with an image sensor. As a result of the measurement, in both the samples A and B, the black line portion corresponding to the guided-mode resonance phenomenon was observed. A position where the black line portion was observed corresponded to a position where the single period of the optical element was 405.7 nm in the sample A and 405.5 nm in the sample B. That is, it can be seen that the corresponding refractive index can be specified by detecting the position of the black line portion corresponding to the refractive index of the refractive liquid on the liquid crystal layer.

### Example 2

Samples A and B were prepared and evaluated in the same manner as in Example 1, except that in Example 1, the thickness of the liquid crystal layer was changed to 1.22 μm, the range of the change in the single period A of the liquid crystal alignment pattern in the plane was changed to 279 μm to 281 μm, and the wavelength of the laser light incident during the evaluation was changed to 450 nm.

As a result of the measurement, in both the samples A and B, a black line portion corresponding to the guided-mode resonance phenomenon was observed. The position where the black line portion was observed corresponded to a position where the single period of the optical element was 280.0 nm in the sample A and 279.9 nm in the sample B. That is, it can be seen that the corresponding refractive index can be specified by detecting the position of the black line portion corresponding to the refractive index of the refractive liquid on the liquid crystal layer.

### Example 3

Samples A and B were prepared and evaluated in the same manner as in Example 1, except that in Example 1, the thickness of the liquid crystal layer was changed to 4.38 μm, the range of the change in the single period A of the liquid crystal alignment pattern in the plane was changed to 979 μm to 981 μm, and the wavelength of the laser light incident during the evaluation was changed to 1550 nm.

As a result of the measurement, in both the samples A and B, a black line portion corresponding to the guided-mode resonance phenomenon was observed. The position where the black line portion was observed corresponded to a position where the single period of the optical element was 980.1 nm in the sample A and 979.8 nm in the sample B. That is, it can be seen that the corresponding refractive index can be specified by detecting the position of the black line portion corresponding to the refractive index of the refractive liquid on the liquid crystal layer.

### Example 4

Samples A and B were prepared and evaluated in the same manner as in Example 1, except that the exposure conditions of the alignment film were changed and the rate of change of the single period A with respect to the distance x, |Λ_{X}−Λ₁|/x, was changed to 4×10⁻³ in Example 1.

As a result of the measurement, in both the samples A and B, a black line portion corresponding to the guided-mode resonance phenomenon was observed. A position where the black line portion was observed corresponded to a position where the single period of the optical element was 405.7 nm in the sample A and 405.5 nm in the sample B. That is, it can be seen that the corresponding refractive index can be specified by detecting the position of the black line portion corresponding to the refractive index of the refractive liquid on the liquid crystal layer.

### Example 5

Samples A and B were prepared and evaluated in the same manner as in Example 1, except that the alignment film was exposed as follows in Example 1.

A right half of the alignment film (referred to as a region E₂) was masked, the left half of the alignment film (referred to as a region E₁) was subjected to mask exposure using the exposure device shown in FIG. 13, the left half of the alignment film (referred to as a region E₁) was masked, and the right half of the alignment film (referred to as a region E₂) was subjected to mask exposure using the exposure device shown in FIG. 14.

The lens was used to adjust the two light intersection angles to change in a plane such that the single period of each of the regions E₁ and E₂ continuously changed from 404 μm to 406 μm with respect to the distance of 5 mm. As a result, an alignment film having an alignment pattern in which the continuous rotation direction in the direction along the one direction is reversed between the region E₁ and the region E₂ was formed. |Λ_{X}−Λ₁|/x, which is a rate of change of the single period A with respect to the distance x, was 4×10⁻⁴ in both the region E₁ and the region E₂, and the direction in which the single period A increased was reversed.

In the sample A, the black line portion could be detected at a position corresponding to a position where the single period was 405.7 nm in each of the region E₁ and the region E₂. In addition, in the sample B, a black line portion could be detected at a position where the single period was 405.5 nm in each of the region E₁ and the region E₂.

Further, in the samples A and B, the intervals between the two black line portions are different, and the refractive index can be detected without specifying the absolute position by measuring the difference in the intervals between the two black line portions.

### Example 6

Samples A and B were prepared and evaluated in the same manner as in Example 1, except that the following composition B-4 was used instead of the composition B-3 and the film thickness of the liquid crystal layer was set to 1.752 μm.

Composition B-4

| | |
|---|---|
| Rod-like liquid crystal compound L-1 | 10.00 parts by mass |
| Rod-like liquid crystal compound L-2 | 90.00 parts by mass |
| Polymerization initiator (IRGACURE OXE01, manufactured by BASF SE) | 1.00 part by mass |
| Chiral agent C-1 | 5.75 parts by mass |
| Leveling agent T-1 | 0.08 parts by mass |
| Methyl ethyl ketone | 4000.00 parts by mass |
| Chiral Agent C-1 | |
| 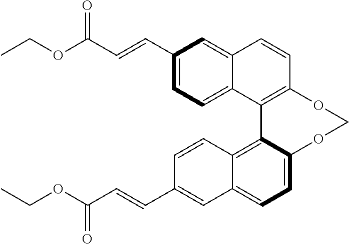 | |

The liquid crystal layer was formed by applying the composition B-4 to the alignment film P-2. After coating, heating, and cooling, ultraviolet curing was performed to produce a liquid crystal immobilized layer.

In the liquid crystal layer, ne(633) was 1.791, no(633) was 1.565, Δn(633) was 0.227, the single period changed in a plane, and a periodic structure due to the cholesteric liquid crystal was formed in the thickness direction, which was verified with a microscope. In addition, the number of cholesteric twists in the thickness direction of the liquid crystal layer was 5, that is, the twist angle was 5×360°=1800°. In addition, in the cross-sectional image by SEM, oblique bright and dark lines were observed with respect to the lower interface (interface with the glass substrate) of the liquid crystal layer, and the interval between the bright and dark lines in the in-plane direction changed as the in-plane position changed.

As a result of the measurement, in both the samples A and B, a black line portion corresponding to the guided-mode resonance phenomenon was observed. A position where the black line portion was observed corresponded to a position where the single period of the optical element was 403.0 nm in the sample A and 402.8 nm in the sample B. That is, it can be seen that the corresponding refractive index can be specified by detecting the position of the black line portion corresponding to the refractive index of the refractive liquid on the liquid crystal layer.

As can be seen from the above results, the effects of the present invention are obvious.

The present invention can be suitably used for a wavelength selective filter, an optical sensor, or the like.

### EXPLANATION OF REFERENCES

12: first sheet
14: second sheet
30: substrate
32: alignment film
40: liquid crystal compound
40A: optical axis
60, 80: exposure device
62, 82: laser
64, 84: light source
65: λ/2 plate
68: beam splitter
70A, 70B, 90A, 90B: mirror
72A, 72B, 96: λ/4 plate
74, 92: lens
86, 94: polarization beam splitter
100, 100b, 100c: optical element
102, 102b, 102c: liquid crystal layer
200: optical sensor
202: light source
204: lens
206: light receiver

What is claimed is:

1. An optical element comprising:
a liquid crystal layer that is formed of a composition including a liquid crystal compound,
wherein the liquid crystal layer has a liquid crystal alignment pattern in which an orientation of an optical axis derived from the liquid crystal compound changes while continuously rotating toward at least one direction of in-plane directions,
in a case where a length over which the orientation of the optical axis derived from the liquid crystal compound rotates by 180° in a plane is set as a single period, a length of the single period in the liquid crystal alignment pattern gradually changes in the one direction, and
the liquid crystal layer further has a resonance structure.

2. The optical element according to claim 1,
wherein the length of the single period in the liquid crystal alignment pattern of the liquid crystal layer is 0.3 μm to 1.2 μm, and
a thickness of the liquid crystal layer is 1 μm to 5 μm.

3. The optical element according to claim 1,
wherein in a region where the length of the single period increases monotonically or decreases monotonically in the one direction, in a case where a length of the single period at a reference position is represented by Λ₁ and a length of the single period at a position spaced from the reference position by a distance x is represented by Λ_{X} with a certain point as a reference,
0<|Λ_{X}−Λ₁|/x≤1×10⁻² is satisfied.

4. The optical element according to claim 1,
wherein the liquid crystal layer has a liquid crystal alignment pattern in which a rotation direction in which the orientation of the optical axis derived from the liquid crystal compound continuously rotates is reversed with a certain point as a boundary in a direction along the one direction.

5. The optical element according to claim 1,
wherein the liquid crystal layer is a layer obtained by immobilizing a cholesteric liquid crystalline phase, and a helical pitch of the liquid crystal layer is 0.1 μm to 0.9 μm.

6. An optical sensor comprising:
the optical element according to claim 1.

7. The optical element according to claim 2,
wherein in a region where the length of the single period increases monotonically or decreases monotonically in the one direction, in a case where a length of the single period at a reference position is represented by Λ₁ and a length of the single period at a position spaced from the reference position by a distance x is represented by Λ_{X} with a certain point as a reference,
0<|Λ_{X}−Λ₁|/x≤1×10⁻² is satisfied.

8. The optical element according to claim 2,
wherein the liquid crystal layer has a liquid crystal alignment pattern in which a rotation direction in which the orientation of the optical axis derived from the liquid crystal compound continuously rotates is reversed with a certain point as a boundary in a direction along the one direction.

9. The optical element according to claim 2,
wherein the liquid crystal layer is a layer obtained by immobilizing a cholesteric liquid crystalline phase, and a helical pitch of the liquid crystal layer is 0.1 μm to 0.9 μm.

10. An optical sensor comprising:
the optical element according to claim 2.

11. The optical element according to claim 3,
wherein the liquid crystal layer has a liquid crystal alignment pattern in which a rotation direction in which the orientation of the optical axis derived from the liquid crystal compound continuously rotates is reversed with a certain point as a boundary in a direction along the one direction.

12. The optical element according to claim 3,
wherein the liquid crystal layer is a layer obtained by immobilizing a cholesteric liquid crystalline phase, and a helical pitch of the liquid crystal layer is 0.1 μm to 0.9 μm.

13. An optical sensor comprising:
the optical element according to claim 3.

14. The optical element according to claim 4,
wherein the liquid crystal layer is a layer obtained by immobilizing a cholesteric liquid crystalline phase, and a helical pitch of the liquid crystal layer is 0.1 μm to 0.9 μm.

15. An optical sensor comprising:
the optical element according to claim 4.

16. An optical sensor comprising:
the optical element according to claim 5.
